(19) United States
(12) Patent Application Publication
(10) Pub. No.: US 2019/0345888 A1
(43) Pub. Date: Nov. 14, 2019

(54) FUEL INJECTION CONTROL DEVICE

(71) Applicant: HONDA MOTOR CO., LTD,., Tokyo (JP)

(72) Inventor: Tatsuo Yamanaka, Wako-shi (JP)

(21) Appl. No.: 16/395,466

(22) Filed: Apr. 26, 2019

(30) Foreign Application Priority Data
May 11, 2018 (JP) 2018-092416

(51) Int. Cl. F02D 41/14; F02D 41/00

(52) U.S. Cl. CPC F02D 41/1402; F02D 41/0085; F02D 2041/1413; F02D 2041/1409; F02D 41/1441

(57) ABSTRACT

A fuel injection control device includes: an energization control unit that controls a fuel injection valve; an inter-terminal voltage acquiring unit that acquires an inter-terminal voltage of the fuel injection valve at a predetermined time interval; and a state determining unit that determines an open-close operation state of the fuel injection valve based on the acquired inter-terminal voltage, wherein the state determining unit sets, for each of the plurality of fuel injections in the fuel injection period, a valve closing determination period after the electricity to the fuel injection valve is turned off, the period having a time length determined according to a number of injection stages of the multi-stage injection, and determines that the fuel injection valve is in a fully closed state when the voltage change due to a valve body movement of the fuel injection valve appears in the inter-terminal voltage acquired in the valve closing determination period.

### INCORPORATION BY REFERENCE

The present application claims priority under 35 U.S.C. § 119 to Japanese Patent Application No. 2018-092416 filed on May 11, 2018. The content of the applications is incorporated herein by reference in its entirety.

### BACKGROUND OF THE INVENTION

### Field of the Invention

The present invention relates to a fuel injection control device for controlling opening and closing of a fuel injection valve of an internal combustion engine.

### Description of the Related Art

As one means for improving the combustion efficiency in the internal combustion engine, multi-stage injection means is known in which fuel injection during a fuel injection period of one combustion cycle is split into a plurality of fuel injections. To perform such multi-stage injection, it is necessary to check whether a fuel injection valve becomes in a fully closed state between the above-described multiple consecutive fuel injections to determine whether the multi-stage injection is properly performed.

As a conventional technique of detecting a moving state of a valve body of the fuel injection valve, it is known that whether the valve body injects as many as the number of times corresponding to an open/close command is determined based on a change in a drive current or a drive voltage that is applied to the fuel injection valve (International Publication No. WO 2016/129402).

However, since the above-described change in the drive current or the drive voltage that is observed in the above-described conventional technique is fine, the change of the voltage waveform to be detected may be buried in an electric noise. Accordingly, the above-described conventional technique causes increase in the processing load necessary for the waveform analysis, and it is not easy to identify and extract a temporal position of a significant fine change indicating the valve body moving state from the noisy drive current waveform or the noisy drive voltage waveform.

A fuel injection control device that controls multi-stage injection of an internal combustion engine is required to effectively detect whether a fully closed state of a fuel injection valve is established between the injection operations during the multi-stage injection.

### SUMMARY OF THE INVENTION

One aspect of the present invention provides a fuel injection control device that controls a multi-stage injection operation in which a fuel injection valve provided in a cylinder of an internal combustion engine performs a plurality of fuel injections in the cylinder during a fuel injection period for the cylinder, the fuel injection control device including: an energization control unit that controls opening and closing of the fuel injection valve by turning on electricity to the fuel injection valve to open the fuel injection valve, and turning off the electricity to close the fuel injection valve; an inter-terminal voltage acquiring unit that acquires an inter-terminal voltage of the fuel injection valve at a predetermined time interval; and a state determining unit that determines an open-close operation state of the fuel injection valve based on the acquired inter-terminal voltage. The state determining unit is configured to set a period of a time length predetermined according to the number of injection stages of the multi-stage injection after the electricity to the fuel injection valve is turned off, as a valve closing determination period, for each of the plurality of fuel injections in the fuel injection period, and determine whether a voltage change caused by a counter electromotive force generated due to a valve body movement of the fuel injection valve has appeared in a change in the inter-terminal voltage acquired in the valve closing determination period, and determine that the fuel injection valve is in a fully closed state when the voltage change appears.

According to another aspect of the present invention, the internal combustion engine includes a plurality of cylinders, and the state determining unit is configured to set the valve closing determination period for each cylinder such that the valve closing determination period for one cylinder does not overlap with a start timing of the fuel injection in another cylinder.

According to still another aspect of the present invention, the state determining unit is configured to determine the predetermined time length of the valve closing determination period according to the number of injection stages of the multi-stage injection and an engine speed of the internal combustion engine.

According to yet another aspect of the present invention, the predetermined time length of the valve closing determination period is set to monotonically increase for decrease in the engine speed of the internal combustion engine, and/or to monotonically increase for decrease in the number of injection stages.

According to further aspect of the present invention, the fuel injection control device further includes a storage device that stores a determination time map indicating the predetermined time length predetermined according to at least the engine speed of the internal combustion engine, and the state determining unit is configured to determine the predetermined time length with reference to the determination time map based on at least setting of the number of injection stages of the multi-stage injection.

According to the present invention, the fuel injection control device that controls the multi-stage injection of the internal combustion engine can effectively detect whether a fully closed state of the fuel injection valve is established between the injection operations during the multi-stage injection.

### BRIEF DESCRIPTION OF THE DRAWINGS

FIG. 1 is a diagram illustrating a configuration of a fuel injection control device according to an embodiment of the present invention;

FIG. 2 is a table showing an example of a determination time map in the fuel injection control device illustrated in FIG. 1;

FIG. 3 is a chart showing an example of a relationship between an execution period of the individual fuel injection and the valve closing determination period, among a plurality of cylinders;

FIG. 4 is a timing chart for explaining an example of operation of the fuel injection control device illustrated in FIG. 1; and

FIG. 5 is a flowchart illustrating a procedure of state determining processes for a valve closing operation in the fuel injection control device illustrated in FIG.

1.

### DETAILED DESCRIPTION OF THE PREFERRED EMBODIMENT

Hereinafter, an embodiment of the present invention will be described with reference to the drawings.

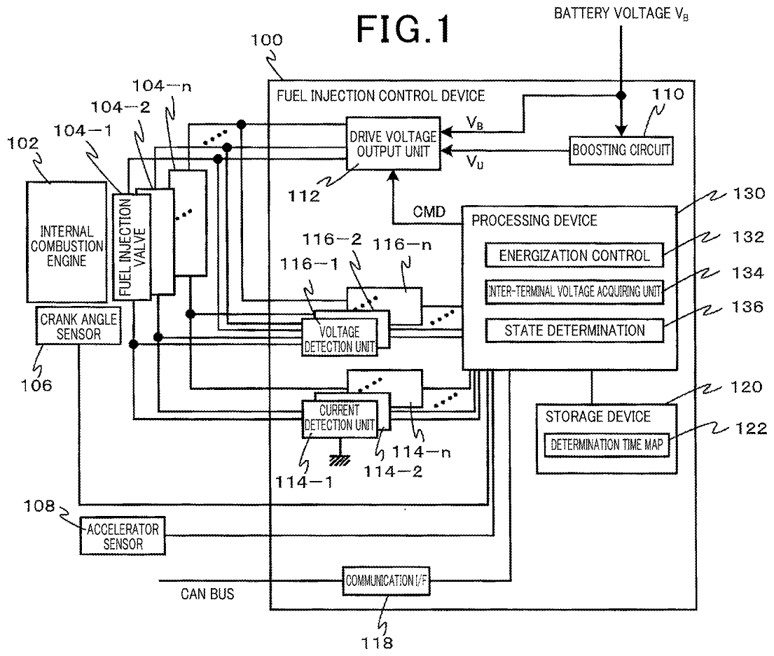

FIG. 1 is a diagram illustrating a configuration of a fuel injection control device according to an embodiment of the present invention.

A fuel injection control device 100 is mounted on a vehicle (not illustrated) using an internal combustion engine 102, for example. The fuel injection control device 100 controls a multi-stage injection operation in which fuel injection valves 104-1, 104-2, . . . , and 104-n respectively provided in a plurality of (n, for example) cylinders (not illustrated) of the internal combustion engine 102 each perform a plurality of fuel injections in the corresponding cylinder during a fuel injection period of one combustion cycle for each cylinder. Hereinafter, the fuel injection period of one combustion cycle is simply referred to as a fuel injection period, and an injection period of each of a plurality of fuel injections in the fuel injection period is referred to as an individual injection period. The fuel injection valves 104-1, 104-2, . . . , and 104-n are generally referred to as the fuel injection valve 104.

The fuel injection control device 100 determines an open-close operation state of the fuel injection valve 104 in the above-described multi-stage injection operation.

The fuel injection valve 104 is, for example, an electromagnetic valve, and includes a valve body provided with a magnet, a spring for urging the valve body toward a valve closing position, and a solenoid coil wound around the magnet of the valve body (all of which are not illustrated). Note that in the following description, energizing the fuel injection valve 104 means energizing the solenoid coil provided in the fuel injection valve 104, and an inter-terminal voltage and a flowing current of the fuel injection valve 104 mean the inter-terminal voltage and the flowing current of the solenoid coil.

The fuel injection control device 100 includes a boosting circuit 110, a drive voltage output unit 112, n current detection units 114-1, 114-2, . . . , and 114-n, n voltage detection units 116-1, 116-2, . . . , and 116-n, a communication interface (I/F) unit 118, a storage device 120, and a processing device 130. Hereinafter, the current detection units 114-1, 114-2, . . . , and 114-n are generally referred to as the current detection unit 114, and the voltage detection units 116-1, 116-2, . . . , and 116-n are generally referred to as the voltage detection unit 116.

The boosting circuit 110 boosts a battery voltage V_{B} supplied from the outside to supply a boosted voltage V_{U} to the drive voltage output unit 112. The drive voltage output unit 112 is a drive circuit configured to output a voltage for driving the fuel injection valves 104-1, 104-2, . . . , and 104-n. The drive voltage output unit 112 is operated by the battery voltage V_{B} and the boosted voltage V_{U}, and outputs the drive voltage to the fuel injection valves 104-1, 104-2, . . . , and 104-n based on an open/close command CMD for individually instructing the fuel injection valves 104-1, 104-2, . . . , and 104-n to be opened or closed, the open/close command CMD being output from the processing device 130.

The current detection units 114-1, 114-2, . . . , and 114-n output, to the processing device 130, respective signals that indicate the magnitudes of flowing currents Iⱼ-1, Iⱼ-2, . . . , and Iⱼ-n, respectively, the flowing currents Iⱼ-1, Iⱼ-2, . . . , and Iⱼ-n flowing in the respective fuel injection valves 104-1, 104-2, . . . , and 104-n. Hereinafter, the flowing currents Iⱼ-1, Iⱼ-2, and Iⱼ-n are generally referred to as the flowing current Iⱼ. The current detection unit 114 is a current detection circuit configured to output a voltage proportional to the flowing current Iⱼ flowing in the corresponding fuel injection valve 104 through a voltage-dividing resistor, for example.

The voltage detection units 116-1, 116-2, and 116-n detect inter-terminal voltages Vₜ-1, Vₜ-2, and Vₜ-n of the fuel injection valves 104-1, 104-2, and 104-n, respectively. Hereinafter, the inter-terminal voltages Vₜ-1, Vₜ-2, and Vₜ-n are generally referred to as the inter-terminal voltage Vₜ. The voltage detection unit 116 is configured by using an AD converter (Analog-to-Digital Converter), for example.

The communication I/F unit 118 is a communication interface designed for the fuel injection control device 100 to communicate with another control device via a bus configuring an in-vehicle network. The communication I/F unit 118 is a transceiver conforming to CAN communication standard, the transceiver being connected to a CAN (Controller Area Network) bus configuring an in-vehicle internal network, for example.

The storage device 120 includes volatile and non-volatile semiconductor memories, and stores a software program and/or data necessary for the operation in the processing device 130. The storage device 120 stores a determination time map 122 indicating time lengths of valve closing determination periods, the time lengths of the valve closing determination periods being predetermined in accordance with an engine speed of the internal combustion engine 102 and the number of injection stages of the multi-stage injection.

Here, the valve closing determination period refers to a period of a predetermined time length for determining a valve closing operation state of the fuel injection valve 104 after electricity to the fuel injection valve 104 is turned off at the end of each of the individual injection periods in the fuel injection period. The number of injection stages of the multi-stage injection refers to the number of fuel injections to be performed in the fuel injection period. Note that in the following description, the number of injection stages of the multi-stage injection is simply referred to as the number of injection stages.

The processing device 130 controls the output voltage of the drive voltage output unit 112 based on a signal from a crank angle sensor 106, a signal from the current detection unit 114, and the like provided in the internal combustion engine 102 to control the operation of the fuel injection valve 104. The processing device 130 determines the valve closing operation state of the fuel injection valve 104 based on a change in the inter-terminal voltage Vₜ of the fuel injection valve 104.

The processing device 130 is, for example, a computer provided with a processor such as a CPU (Central Processing Unit). The processing device 130 may include a ROM (Read Only Memory) in which a program is written, a RAM (Random Access Memory) in which data is temporarily stored, and the like. The processing device 130 includes an energization control unit 132, an inter-terminal voltage acquiring unit 134, and a state determining unit 136 as functional elements (or functional units).

Note that in the following description of the processing device 130, the operations common to each of n cylinders are described using the general terms of the “fuel injection valve 104,” the “current detection unit 114,” and the “voltage detection unit 116.” Note that in the description, this means that the processing device 130 actually performs the operation of each of the fuel injection valves 104-1, 104-2, . . . , and 104-n using the respective corresponding current detection units 114-1, 114-2, . . . , and 114-n and the respective corresponding voltage detection units 116-1, 116-2, . . . , and 116-n.

These functional elements included in the processing device 130 are implemented by causing the processing device 130 as a computer to execute a program, for example. Note that the above-described computer program can be stored in any computer readable storage medium in advance. Alternatively, all or part of the above-described functional elements included in the processing device 130 each can be configured from hardware including at least one electronic circuit component.

The energization control unit 132 transmits an open/close command CMD to the drive voltage output unit 112, the open/close command CMD including the instruction information for instructing the individual fuel injection valve 104 to be opened or closed. Thereby, the energization control unit 132 turns on the electricity to the fuel injection valve 104 to open the fuel injection valve 104, and turns off the electricity to close the fuel injection valve 104, to control the opening and closing of the fuel injection valve 104. Specifically, the energization control unit 132 controls the output voltage of the drive voltage output unit 112, that is, an on/off operation of a drive voltage for energizing the fuel injection valve 104 and a value of the drive voltage, based on a signal from the crank angle sensor 106 and a signal from an accelerator sensor 108. Thereby, the energization control unit 132 opens and closes the fuel injection valve 104 a plurality of times during the fuel injection period of one combustion cycle of the internal combustion engine 102 to perform the multi-stage injection in which a plurality of fuel injections are performed.

More specifically, the energization control unit 132 controls the open/close timing of the fuel injection valve 104, based on the signal from the crank angle sensor 106. Also, the energization control unit 132 controls a valve opening time of the fuel injection valve 104 such that a total fuel injection amount of the multi-stage injection during one combustion cycle becomes a target fuel injection amount according to a signal from the accelerator sensor 108.

The inter-terminal voltage acquiring unit 134 acquires the inter-terminal voltage Vₜ of the fuel injection valve 104 at a predetermined time interval from the voltage detection unit 116.

The state determining unit 136 determines the open-close operation state of the fuel injection valve 104 based on the inter-terminal voltage Vₜ of the fuel injection valve 104 acquired by the inter-terminal voltage acquiring unit 134.

In particular, the state determining unit 136 sets, for each of the plurality of fuel injections in the fuel injection period, a valve closing determination period having a time length after the electricity to the fuel injection valve 104 is turned off. Also, the state determining unit 136 determines whether a voltage change caused by a counter electromotive force generated due to the valve body movement of the fuel injection valve 104 has appeared in a change in the inter-terminal voltage acquired by the inter-terminal voltage acquiring unit 134 in the valve closing determination period. When such a voltage change has appeared, the state determining unit 136 determines that the fuel injection valve 104 is in a fully closed state.

In the present embodiment, the state determining unit 136 determines the time length of the valve closing determination period as the time length according to the engine speed of the internal combustion engine 102 and the number of injection stages of the multi-stage injection, with reference to the determination time map 122 stored in the storage device 120 in advance.

Specifically, the state determining unit 136 acquires a current engine speed of the internal combustion engine 102 from the crank angle sensor 106 at a predetermined time interval, for example, and acquires the current setting of the number of injection stages from the energization control unit 132. The state determining unit 136 determines a time length of the valve closing determination period with reference to the determination time map 122 based on the current engine speed of the internal combustion engine 102 and the current number of injection stages at the start of one combustion cycle of a predetermined cylinder, for example, or at the start of the intake stroke, for example.

Subsequently, when the energization of the fuel injection valve 104 is switched from on to off, the state determining unit 136 determines that the valve closing determination period is started, and starts to acquire the inter-terminal voltage Vₜ from the voltage detection unit 116. When the valve closing determination period is completed, the state determining unit 136 terminates the acquisition of the inter-terminal voltage Vₜ. More specifically, the state determining unit 136 repeatedly acquires the inter-terminal voltage Vₜ from the voltage detection unit 116 at a predetermined time interval in the above-described valve closing determination period. Thereby, the state determining unit 136 acquires the changing waveform of the inter-terminal voltage Vₜ in the above-described valve closing determination period.

The state determining unit 136 determines whether a voltage change (valve closing waveform) caused by a counter electromotive force generated due to the valve body movement of the fuel injection valve 104 has been detected from the changing waveform of the inter-terminal voltage Vₜ acquired as described above. When the valve closing waveform is detected, the state determining unit 136 determines that the fuel injection valve 104 is in a fully closed state.

The state determining unit 136 holds a valve closing flag indicating a valve closed state of the fuel injection valve 104, for example. The state determining unit 136 resets the valve closing flag to zero at the start of the fuel injection period, and sets the valve closing flag to 1 when the state determining unit 136 determines that the fuel injection valve 104 is in a fully closed state at the end of the individual injection period. Note that the valve closing flag is provided in correspondence to each of the plurality of cylinders such that based on the determination for each of the plurality of cylinders on whether the individual fuel injection valve 104 has been shifted to the fully closed state, the valve closing flag of the corresponding cylinder is set.

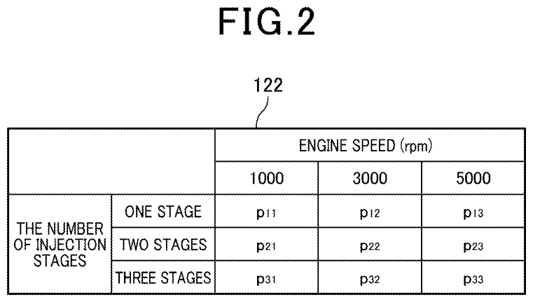

FIG. 2 is a table showing an example of the determination time map 122. In the example illustrated in FIG. 2, the determination time map 122 represents, in tabular form, predetermined time lengths of the valve closing determination periods according to the engine speed of the internal combustion engine 102 and the number of injection stages of the multi-stage injection.

Here, the predetermined time lengths of the valve closing determination periods shown in the determination time map 122 are determined such that the valve closing determination period for one cylinder does not overlap with the start timing of the fuel injection in another cylinder. Thereby, the noise from the fuel injection valve 104 corresponding to another cylinder at the start of the fuel injection of the cylinder is superimposed on the waveform of the inter-terminal voltage Vₜ of the one cylinder, which can prevent an error in determining whether the fuel injection valve 104 corresponding to the one cylinder has been shifted to the fully closed state.

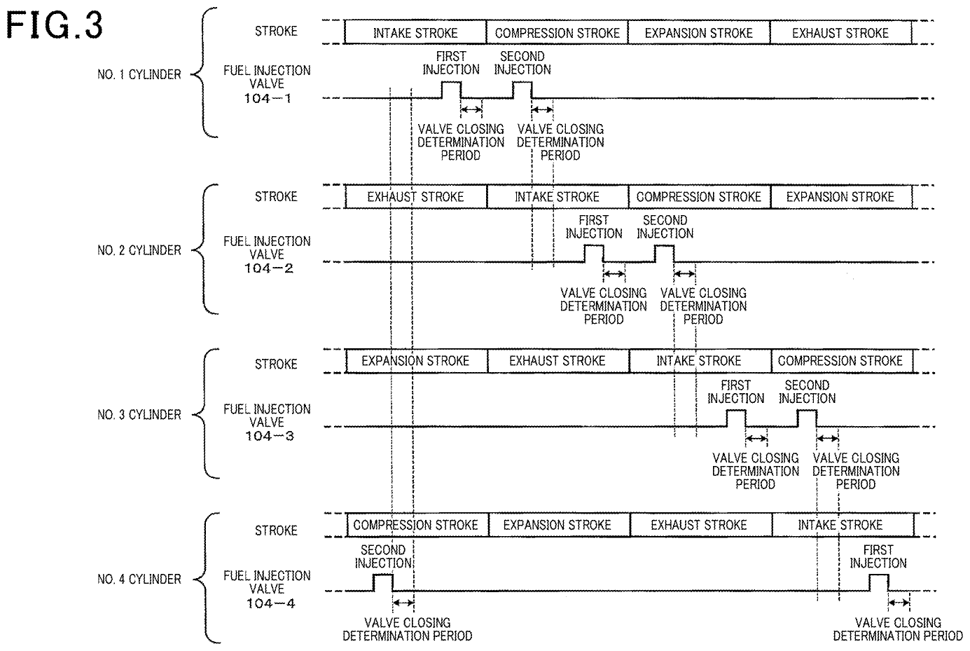

FIG. 3 is a chart showing an example of a relationship between an execution period of the individual fuel injection and the valve closing determination period, in each cylinder. In an example shown in FIG. 3, n is four. The uppermost stage of FIG. 3 shows an operation of No. 1 (#1) cylinder, and the operations of No. 2 (#2) cylinder, No. 3 (#3) cylinder, and No. 4 (#4) cylinder are shown in this order toward a lower side. In FIG. 3, an upper portion of a chart for each cylinder shows a stroke cycle of each cylinder, and a lower portion thereof shows a waveform of the valve opening operation of the fuel injection valve 104 corresponding to each cylinder. In the example shown in FIG. 3, the number of injection stages of each cylinder is set to two, and the fuel is injected one time in each of the intake stroke and the compression stroke. In FIG. 3, the two fuel injections for each cylinder are indicated as a “first injection” and a “second injection.” After each fuel injection is completed, the valve closing determination period having the same length is provided.

As shown in FIG. 3, the time length of the valve closing determination period is determined such that the valve closing determination period for one cylinder does not overlap with the start timing of the fuel injection in another cylinder. For example, the valve closing determination periods for the second injections of the No. 1 cylinder, the No. 2 cylinder, the No. 3 cylinder, and the No. 4 cylinder as one cylinder are determined not to overlap with the start timings of the first injections of the No. 2 cylinder, the No. 3 cylinder, the No. 4 cylinder and the No. 1 cylinder, respectively as another cylinder.

Returning to FIG. 2, the predetermined time lengths shown in the determination time map 122 are discretely set to monotonically increase for decrease in the engine speed of the internal combustion engine 102, and to monotonically increase for decrease in the number of injection stages. That is, the predetermined time lengths shown in the determination time map 122 are set such that p₁ₘ≥p₂ₘ≥p₃ₘ, (m=1, 2, 3) and pₖ₁≥pₖ₂≥pₖ₃ (k=1, 2, 3) are established.

The minimum value of the above-described predetermined time length is set to be longer than, for example, the minimum operation time of the fuel injection valve 104 (that is, a standard reference value of the minimum time elapsed until the valve body is seated at the valve closing position after the applied voltage is turned off). Note that the maximum value of the above-described predetermined time length in each injection stage is determined as the longest time length, for example, within a range satisfying the above-described conditions in the corresponding injection stage, that is, within a range that the valve closing determination period for one cylinder does not overlap with the start timing of the fuel injection in another cylinder.

Thus, the reason why the time length of the valve closing determination period is determined to monotonically increase for decrease in the engine speed of the internal combustion engine 102, and to monotonically increase for decrease in the number of injection stages is as follows.

The valve closing waveform for the inter-terminal voltage Vₜ associated with the valve closing operation of the fuel injection valve 104 is determined according to a change in magnetic flux inside the fuel injection valve 104 as a solenoid, the change occurring until the valve body contacts a valve-closing seat position after being away from the valve opening position. The rate of change in magnetic flux is defined by a moving speed of the valve body, and the moving speed of the valve body is defined by the strength of the spring for urging the valve body toward the valve-closing seat position and the pressure of the fuel flowing into the fuel injection valve 104. That is, as the fuel pressure is reduced, the moving speed of the valve body is reduced and the rate of change in magnetic flux is reduced, whereby the magnitude of change in the inter-terminal voltage Vₜ associated with the valve closing operation of the fuel injection valve 104, that is, the magnitude of the valve closing waveform (the magnitude of the amplitude of the valve closing waveform) is further reduced. Since the distance to move until the valve body contacts the valve-closing seat position after being away from the valve opening position is constant, as the moving speed of the valve body is decreased, the moving time of the valve body or the time for the change in magnetic flux is increased, and the duration of the valve closing waveform is increased. That is, as the moving speed of the valve body is decreased, the valve closing waveform becomes small and lasts long.

Typically, as the engine speed of the internal combustion engine 102 is higher and the number of injection stages is greater, the fuel pressure is increased and the moving speed of the valve body is increased. Accordingly, the rate of change in magnetic flux is also increased, and the valve closing waveform of a temporal change in the inter-terminal voltage Vₜ may be steep and have a relatively large amplitude. In other words, since the valve closing waveform is detected more easily as the engine speed of the internal combustion engine 102 is higher and the number of injection stages is greater, the time length of the valve closing determination period can be further reduced.

On the contrary, since the fuel pressure is typically set low as the engine speed of the internal combustion engine 102 is lower and the number of injection stages is smaller, the moving speed of the valve body is decreased. Accordingly, the rate of change in magnetic flux is also decreased, and the valve closing waveform has a small amplitude and long duration, and becomes smooth. In other words, since the valve closing waveform is buried in the noise, which makes it difficult to detect the valve closing waveform, and may have long duration as the engine speed of the internal combustion engine 102 is lower and the number of injection stages is smaller, it may be desirable to set the time length of the valve closing determination period to be longer to increase the amount of data used for the process of detecting the valve closing waveform.

For the above-described reason, in the present embodiment, the predetermined time length of the valve closing determination period is determined to monotonically increase for decrease in the engine speed of the internal combustion engine 102, and to monotonically increase for decrease in the number of injection stages.

However, the aforementioned is an example, and when a change in the magnitude of the valve closing waveform is small with respect to a change in the number of injection stages, for example, the length of the valve closing determination period can be set to monotonically increase only for decrease in the engine speed of the internal combustion engine 102 regardless of the number of injection stages. When a change in the magnitude of the valve closing waveform is small with respect to a change in the engine speed, for example, the length of the valve closing determination period can be set to monotonically increase only for decrease in the number of injection stages regardless of the engine speed. In other words, the time length of the valve closing determination period can be defined according to at least one of the engine speed of the internal combustion engine 102 and the number of injection stages. Accordingly, the determination time map 122 can also show the predetermined time lengths in accordance with at least one of the engine speed of the internal combustion engine 102 and the number of injection stages of the multi-stage injection.

Furthermore, the time length of the valve closing determination period set according to a specified engine speed and/or the specified number of injection stages may be shorter than that set according to higher engine speed and/or the greater number of injection stages, depending on the control aspect of the internal combustion engine 102, for example.

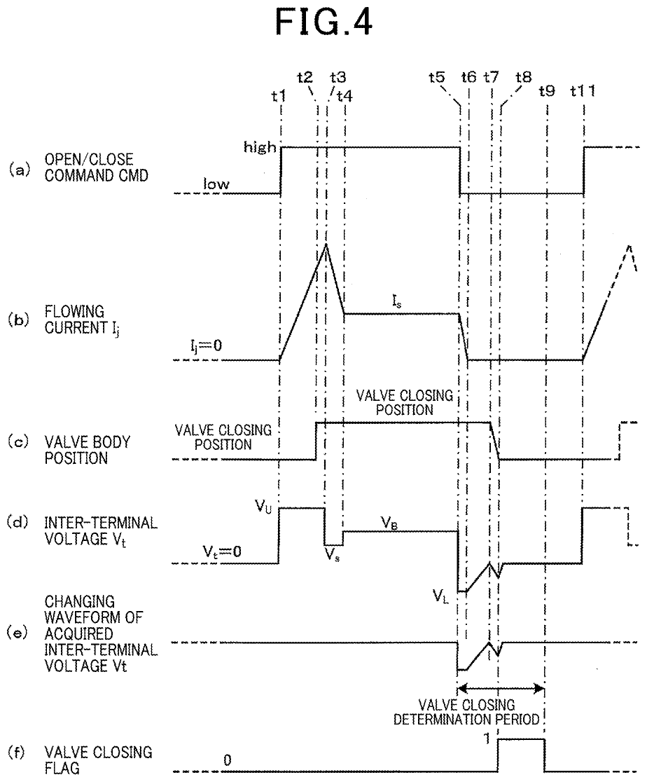

FIG. 4 is a timing chart for explaining an example of operation in the fuel injection control device 100. FIG. 4 shows changes over time in (a) an open/close command CMD output to the drive voltage output unit 112 from the energization control unit 132, (b) a flowing current Iⱼ flowing in the fuel injection valve 104 detected by the current detection unit 114, (c) a valve body position of the fuel injection valve 104, (d) an inter-terminal voltage Vₜ of the fuel injection valve 104 detected by the voltage detection unit 116, (e) a changing waveform of the inter-terminal voltage Vₜ acquired by the state determining unit 136, and (f) a value of the valve closing flag, in this order from the uppermost stage.

When a signal to instruct an intended fuel injection valve 104 to be opened is set to high to instruct the fuel injection valve 104 to be opened at a time t1, the signal being included in the open/close command CMD, the individual injection period is started ((a) of FIG. 4). Hereinafter, a “signal to instruct the intended fuel injection valve 104 to be opened, the signal being included in the open/close command CMD” is simply referred to as the open/close command CMD.

When the open/close command CMD is set to high, the boosted voltage V_{U} is applied to the intended fuel injection valve 104 from the drive voltage output unit 112 ((d) of FIG. 4). Thereby, the flowing current Iⱼ of the fuel injection valve 104 is rapidly increased ((b) of FIG. 4). Then, at a time t2 when the force acting on the valve body of the fuel injection valve 104 exceeds a predetermined level due to increasing flowing current Iⱼ, the valve body of the fuel injection valve 104 instantly moves to the valve opening position to start the fuel injection ((c) of FIG. 4).

Then, at a time t3 when a predetermined necessary and sufficient time for completion of opening of the fuel injection valve 104 has elapsed since the time t1 when the open/close command CMD is set to high, the voltage applied to the fuel injection valve 104 from the drive voltage output unit 112 is switched to the battery voltage V_{B} that is at a necessary and sufficient level to hold the valve body at the valve opening position. Thereby, the flowing current Iⱼ is decreased, and at a time t4, the flowing current Iⱼ converges on a current value I_{S} defined by the battery voltage V_{B} and a direct current resistance of the fuel injection valve 104 ((b) of FIG. 4).

At this time, in a period from the times t3 to t4, the inter-terminal voltage Vₜ of the fuel injection valve 104 is decreased to the voltage V_{S} lower than the battery voltage V_{B} due to a counter electromotive voltage generated in the solenoid of the fuel injection valve 104 along with the decrease in the flowing current Iⱼ. At the time t4 when the flowing current Iⱼ converges on the current value I_{S}, the inter-terminal voltage Vₜ becomes the battery voltage V_{B} ((d) of FIG. 4). Then, at a time t5 when a predetermined time determined based on the target fuel injection amount has elapsed since the time t1, the open/close command CMD is set to low ((a) of FIG. 4), and the applied voltage to the fuel injection valve 104 from the drive voltage output unit 112 is turned off.

Thereby, the flowing current Iⱼ is decreased, and at a time t6, the flowing current Iⱼ becomes zero ((b) of FIG. 4). The counter electromotive voltage is generated in the fuel injection valve 104 due to this decrease in flowing current Iⱼ, whereby the inter-terminal voltage Vₜ is decreased to a negative voltage V_{L} at the time t5 ((d) of FIG. 4). After the time t6 when the flowing current Iⱼ becomes zero, the inter-terminal voltage Vₜ is increased toward zero volts with a time constant defined by a circuit constant of a discharge circuit including the fuel injection valve 104 and its peripheral circuit.

On the other hand, in the valve body of the fuel injection valve 104, since the flowing current Iⱼ is zero, the magnetic field generated in the fuel injection valve 104 is reduced. Thereby, at a time t7 when an electromagnetic force acting on the valve body is weaker than a force of the spring for urging the valve body toward a valve closing position in the fuel injection valve 104, the valve body starts to move toward the valve closing position, and at a time t8, the valve body is seated at the valve closing position ((c) of FIG. 4).

The counter electromotive voltage is generated in the fuel injection valve 104 again due to this movement of the valve body, and in a period from the times t7 to t8 during the valve body is moved, the inter-terminal voltage Vₜ is decreased once. Then, from the time t8 when the valve body is seated at the valve closing position, the inter-terminal voltage Vₜ is increased to zero volts with the above-mentioned time constant ((d) of FIG. 4).

On the other hand, when the open/close command CMD is set to low at the time t5, the state determining unit 136 sets the valve closing determination period starting from the time t5, and acquires the changing waveform of the inter-terminal voltage Vₜ in the valve closing determination period ((e) of FIG. 4).

The state determining unit 136 detects a voltage change during a period from the times t7 to t8, the voltage change being caused by a counter electromotive voltage (or a counter electromotive force) generated due to the valve body movement to the valve closing position, based on the changing waveform of the inter-terminal voltage Vₜ acquired in the above-described valve closing determination period, and determines that the valve body of the fuel injection valve 104 is in the valve closed state. Thereby, the state determining unit 136 sets the valve closing flag to 1 ((f) of FIG. 4). Then, the state determining unit 136 resets the valve closing flag to zero at a time t9 when the valve closing determination period is completed, and is ready for the determination of the valve closed state in the next valve closing determination period ((f) of FIG. 4).

Then, when the open/close command CMD is set to high again at a time t11, the next individual injection period is started ((a) of FIG. 4).

In the fuel injection control device 100 having the above-described configuration, the state determining unit 136 sets a valve closing determination period having a time length that starts after the electricity to the fuel injection valve 104 is turned off, and acquires the changing waveform of the inter-terminal voltage Vₜ only in the valve closing determination period. The fuel injection control device 100 determines whether the fuel injection valve 104 has been shifted to the fully closed state, based on the acquired changing waveform (inter-terminal voltage waveform) of the inter-terminal voltage Vₜ.

More specifically, the fuel injection control device 100 specifies or acquires in advance the inter-terminal voltage waveform in a period during the valve closing operation is to be performed, and determines whether the fuel injection valve 104 has been shifted to the fully closed operation, based on the inter-terminal voltage waveform. Therefore, the fuel injection control device 100 can effectively detect whether a fully closed state of the fuel injection valve 104 is established, by performing a detailed analysis of the above-described extracted inter-terminal voltage waveform while reducing a processing load of the processing device 130 even if there are influences of electric noises.

The fuel injection control device 100 may be configured to determine a time length of the valve closing determination period according to both or one of the engine speed of the internal combustion engine 102 and the number of injection stages of the multi-stage injection. Therefore, the fuel injection control device 100 can properly detect the valve closing waveform changing according to the fuel pressure applied to the fuel injection valve 104, and correctly determine whether the fuel injection valve 104 has been shifted to the fully closed state. When the engine speed of the internal combustion engine 102 is in a low-speed range and/or the number of injection stages is small, the time length of the valve closing determination period is set to be longer, whereby the fuel injection control device 100 can detect not only whether the valve closing state is established, but also abnormalities such as the delay of the valve closing timing to predict a failure of the fuel injection valve 104.

Furthermore, in the fuel injection control device 100, the time lengths of the valve closing determination periods predetermined according to the engine speed of the internal combustion engine 102 and/or the number of injection stages are stored in the determination time map 122. Therefore, the fuel injection control device 100 can detect whether the fully closed state of the fuel injection valve 104 is established by easily defining the time length of the valve closing determination period with reference to the determination time map 122.

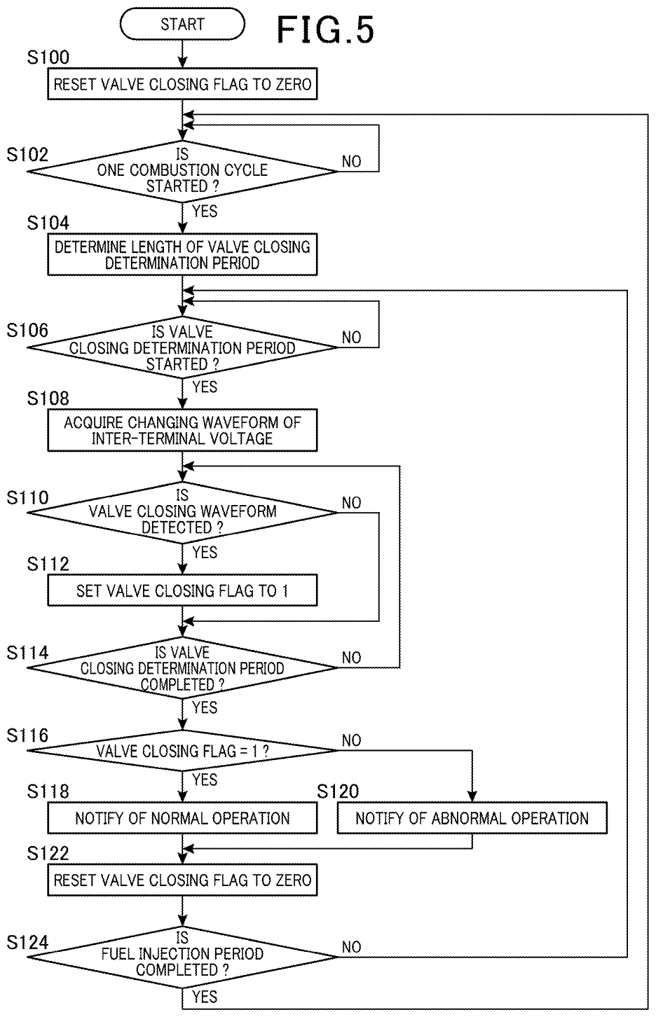

Next, the procedure of the state determining processes for the valve closing operation in the fuel injection control device 100 will be described using a flowchart illustrated in FIG. 5. This operation is started when the power supply of the fuel injection control device 100 is turned on, and is ended when the power supply of the fuel injection control device 100 is turned off.

When the process is started, the state determining unit 136 resets the valve closing flag to zero (S100).

Next, the state determining unit 136 determines whether one combustion cycle has been started (S102). When the one combustion cycle is not started (S102, NO), and returns to step S102 to wait for the start of one combustion cycle. Here, the state determining unit 136 can determine whether the one combustion cycle has been started, based on the current crank angle acquired from the crank angle sensor 106. The state determining unit 136 can also determine that the one combustion cycle is started when the above-described current crank angle corresponds to the start of the intake stroke in the one combustion cycle.

On the other hand, when the one combustion cycle is started (S102, YES), the state determining unit 136 determines the time length of the valve closing determination period (S104). The state determining unit 136 determines the time length of the valve closing determination period as described above, based on the current engine speed of the internal combustion engine 102 and the current number of injection stages that are acquired from the crank angle sensor 106 and the energization control unit 132, respectively, for example, with reference to the determination time map 122.

Subsequently, the state determining unit 136 determines whether the valve closing determination period has been started (S106). This determination is performed by the state determining unit 136, based on the falling of a signal to instruct the intended fuel injection valve 104 to be opened, the signal being included in the open/close command CMD output by the energization control unit 132, that is, whether the transition from high to low has been detected. Hereinafter, a “signal to instruct the intended fuel injection valve 104 to be opened, the signal being included in the open/close command CMD” is simply referred to as the “open/close command CMD” or “CMD.”

For example, the state determining unit 136 acquires the information on the state of the CMD from the energization control unit 132 at a predetermined time interval, and determines that the valve closing determination period is started, when the above-described transition is detected based on the acquired information.

When the valve closing determination period is not started (S106, NO), the state determining unit 136 returns to step S106 to wait for the start of the valve closing determination period. On the other hand, when the valve closing determination period is started (S106, YES), the state determining unit 136 repeatedly acquires the inter-terminal voltage Vₜ in the valve closing determination period at a predetermined time interval from the inter-terminal voltage acquiring unit 134 to acquire the changing waveform of the inter-terminal voltage Vₜ in the above-described valve closing determination period (S108).

Next, the state determining unit 136 determines whether a voltage change (valve closing waveform) caused by a counter electromotive force generated due to the valve body movement of the fuel injection valve 104 has been detected from the changing waveform of the inter-terminal voltage Vₜ input from the inter-terminal voltage acquiring unit 134 (S110). When the valve closing waveform has been detected (S110, YES), the state determining unit 136 sets the valve closing flag to 1 (S112). Subsequently, the state determining unit 136 determines whether the valve closing determination period has been completed (S114). This determination can be performed by the state determining unit 136 using the time length of the valve closing determination period determined in step S104 and a timer (not illustrated) included in the processing device 130.

On the other hand, when the valve closing waveform is not detected in step S110 (S110, NO), the process proceeds to step S114 without setting the valve closing flag by the state determining unit 136, and the state determining unit 136 determines whether the valve closing determination period has been completed.

When the valve closing determination period is not completed (S114, NO), the state determining unit 136 returns to step S110 to repeat the process. On the other hand, when the valve closing determination period is completed in step S114 (S114, YES), the state determining unit 136 determines whether the valve closing flag is set to 1 (S116). When the valve closing flag is set to 1 (S116, YES), the state determining unit 136 notifies a management device (not illustrated) for performing the operation management, for example, through the communication I/F unit 118 that the normal operation is performed, that is, the fuel injection valve 104 is correctly closed when the individual injection period is completed (S118). Subsequently, the state determining unit 136 resets the valve closing flag to zero (S122).

Then, the state determining unit 136 determines whether the fuel injection period has been completed based on the current crank angle acquired from the crank angle sensor 106, for example (S124). When the fuel injection period is not completed (S124, NO), the state determining unit 136 returns to step S106 to repeat the process. On the other hand, when the fuel injection period is completed (S124, YES), the state determining unit 136 returns to step S102 to repeat the process.

On the other hand, when the valve closing flag is not set to 1 in step S116 (S116, NO), the state determining unit 136 notifies the above-described management device, for example, through the communication I/F unit 118 that the abnormal operation is performed, that is, the fuel injection valve 104 is not correctly closed when the individual injection period is completed (S120). Then, the state determining unit 136 moves the process to step S122.

As described above, the fuel injection control device 100 according to the present embodiment controls the multi-stage injection operation in which the fuel injection valve 104 provided in a cylinder of the internal combustion engine 102 performs a plurality of fuel injections in the cylinder during a fuel injection period for such a cylinder. The fuel injection control device 100 includes the energization control unit 132 that controls the opening and closing of the fuel injection valve 104 by turning on the electricity to the fuel injection valve 104 to open the fuel injection valve 104, and turning off the electricity to close the fuel injection valve 104. Furthermore, the fuel injection control device 100 includes the inter-terminal voltage acquiring unit 134 that acquires the inter-terminal voltage Vₜ of the fuel injection valve 104 at a predetermined time interval, and the state determining unit 136 that determines the open-close operation state of the fuel injection valve 104 based on the inter-terminal voltage Vₜ acquired as described above.

The state determining unit 136 sets, for each of the plurality of fuel injections in the above-described fuel injection period, a valve closing determination period having a time length after the electricity to the fuel injection valve 104 is turned off. Also, the state determining unit 136 determines whether a voltage change (valve closing waveform) caused by a counter electromotive force generated due to the valve body movement of the fuel injection valve 104 has appeared in a change in the inter-terminal voltage Vₜ (inter-terminal voltage waveform) acquired in the above-described valve closing determination period. When such a voltage change has appeared, the state determining unit 136 determines that the fuel injection valve 104 is in a fully closed state.

According to this configuration, the state determining unit 136 extracts only the inter-terminal voltage waveform in a period during the valve closing operation is to be performed by setting the valve closing determination period, and determines whether the fuel injection valve 104 has been shifted to the fully closed operation, based on the inter-terminal voltage waveform. Therefore, the fuel injection control device 100 can effectively detect whether a fully closed state of the fuel injection valve 104 is established, by performing a detailed analysis of the above-described extracted inter-terminal voltage waveform while reducing a processing load of the processing device 130 even if there are influences of electromagnetic radiation noises from a spark plug and the like of the internal combustion engine 102.

In the fuel injection control device 100 of the present embodiment, the state determining unit 136 sets the valve closing determination period for each cylinder, such that the valve closing determination period for one cylinder among the plurality of cylinders included in the internal combustion engine 102 does not overlap with the start timing of the fuel injection in another cylinder. According to this configuration, the noise from the fuel injection valve 104 corresponding to another cylinder at the start of the fuel injection of the cylinder is superimposed on the inter-terminal voltage waveform of the one cylinder, which can prevent an error in determining whether the fuel injection valve 104 corresponding to the one cylinder has been shifted to the fully closed state.

In the fuel injection control device 100 of the present embodiment, the state determining unit 136 is configured to define the time length of the valve closing determination period according to at least one of the engine speed of the internal combustion engine 102 and/or the number of injection stages of the multi-stage injection. According to this configuration, the length of the valve closing determination period is determined based on the engine speed of the internal combustion engine 102 and the number of injection stages depending on the fuel pressure applied to the fuel injection valve 104. Accordingly, the state determining unit 136 can set a valve closing determination period in accordance with a magnitude and duration of the valve closing waveform in the inter-terminal voltage waveform changing together with a moving speed of the valve body of the fuel injection valve 104 that may vary depending on the fuel pressure. As a result, the state determining unit 136 can properly determine whether the fuel injection valve 104 has been shifted to the fully closed state using the amount of data in accordance with the magnitude and duration of the valve closing waveform. When the engine speed of the internal combustion engine 102 is in a low-speed range and the number of injection stages is small, the state determining unit 136 can also detect abnormalities such as the delay of the valve closing timing by setting the time length of the valve closing determination period to be longer, and therefore can detect not only the valve closing state, but also predict a failure.

In the fuel injection control device 100 of the present embodiment, the time length of the valve closing determination period is set to monotonically increase for decrease in the engine speed of the internal combustion engine 102, and/or to monotonically increase for decrease in the number of injection stages. According to this configuration, when the reduction in the fuel pressure applied to the fuel injection valve 104 associated with the reduction in the engine speed and the reduction in the number of injection stages causes the reduction in the moving speed of the valve body to the valve closing position, whereby the duration of the valve closing waveform in the inter-terminal voltage waveform becomes longer and the amplitude of the valve closing waveform becomes smaller, which makes it difficult to detect the valve closing waveform, the fuel injection control device 100 can secure sufficient processing data to properly determine whether the fuel injection valve 104 has been shifted to the fully closed state.

The fuel injection control device 100 of the present embodiment includes the storage device 120 that stores the determination time map 122 indicating time lengths of the valve closing determination periods, the time lengths of the valve closing determination periods being predetermined in accordance with at least one of the engine speed of the internal combustion engine 102 and the number of injection stages of the multi-stage injection. The state determining unit 136 determines the above-described time length with reference to the determination time map 122 based on the setting of the current engine speed of the internal combustion engine 102 and/or the current number of injection stages of the multi-stage injection.

According to this configuration, the fuel injection control device 100 can effectively detect whether the fully closed state of the fuel injection valve 104 is established by easily defining the valve closing determination period having the time length predetermined according to the engine speed of the internal combustion engine 102 and/or the number of injection stages with reference to the determination time map 122.

### REFERENCE SIGNS LIST

100 Fuel injection control device
102 Internal combustion engine
104, 104-1, 104-2, 104-n Fuel injection valve
106 Crank angle sensor
108 Accelerator sensor
110 Boosting circuit
112 Drive voltage output unit
114, 114-1, 114-2, 114-n Current detection unit
116, 116-1, 116-2, 116-n Voltage detection unit
118 Communication interface (I/F) unit
120 Storage device
122 Determination time map
130 Processing device
132 Energization control unit
134 Inter-terminal voltage acquiring unit
136 State determining unit

What is claimed is:

1. A fuel injection control device that controls a multi-stage injection operation in which a fuel injection valve provided in a cylinder of an internal combustion engine performs a plurality of fuel injections in the cylinder during a fuel injection period for the cylinder, the fuel injection control device comprising:
an energization control unit that controls opening and closing of the fuel injection valve by turning on electricity to the fuel injection valve to open the fuel injection valve, and turning off the electricity to close the fuel injection valve;
an inter-terminal voltage acquiring unit that acquires an inter-terminal voltage of the fuel injection valve at a predetermined time interval; and
a state determining unit that determines an open-close operation state of the fuel injection valve based on the acquired inter-terminal voltage,
wherein the state determining unit is configured to:
set, for each of the plurality of fuel injections in the fuel injection period, a valve closing determination period after the electricity to the fuel injection valve is turned off, wherein the period has a time length predetermined according to a number of injection stages of the multi-stage injection, and
determine whether a voltage change caused by a counter electromotive force generated due to a valve body movement of the fuel injection valve has appeared in a change in the inter-terminal voltage acquired in the valve closing determination period, and determine that the fuel injection valve is in a fully closed state when the voltage change appears.

2. The fuel injection control device according to claim 1, wherein
the internal combustion engine includes a plurality of cylinders, and
the state determining unit is configured to set the valve closing determination period for each cylinder such that the valve closing determination period for one cylinder does not overlap with a start timing of the fuel injection in another cylinder.

3. The fuel injection control device according to claim 1, wherein
the state determining unit is configured to determine the time length of the valve closing determination period according to the number of injection stages of the multi-stage injection and an engine speed of the internal combustion engine.

4. The fuel injection control device according to claim 2, wherein
the state determining unit is configured to determine the time length of the valve closing determination period according to the number of injection stages of the multi-stage injection and an engine speed of the internal combustion engine.

5. The fuel injection control device according to claim 3, wherein
the time length of the valve closing determination period is set to monotonically increase for decrease in the engine speed of the internal combustion engine, and/or to monotonically increase for decrease in the number of injection stages.

6. The fuel injection control device according to claim 4, wherein
the time length of the valve closing determination period is set to monotonically increase for decrease in the engine speed of the internal combustion engine, and/or to monotonically increase for decrease in the number of injection stages.

7. The fuel injection control device according to claim 1, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.

8. The fuel injection control device according to claim 2, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.

9. The fuel injection control device according to claim 3, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.

10. The fuel injection control device according to claim 4, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.

11. The fuel injection control device according to claim 5, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.

12. The fuel injection control device according to claim 6, further comprising a storage device that stores a determination time map indicating the time length predetermined according to at least the engine speed of the internal combustion engine,
wherein the state determining unit is configured to determine the time length with reference to the determination time map based on at least setting of the number of injection stages of the multi-stage injection.
